(19) United States
(12) Patent Application Publication
(10) Pub. No.: US 2014/0132996 A1
(43) Pub. Date: May 15, 2014

(54) COMMUNICATION APPARATUS HAVING FAX FUNCTION, CONTROL METHOD THEREFOR, AND STORAGE MEDIUM

(71) Applicant: CANON KABUSHIKI KAISHA, Tokyo (JP)

(72) Inventor: Norihisa Kishimoto, Kawasaki-shi (JP)

(73) Assignee: CANON KABUSHIKI KAISHA, Tokyo (JP)

(21) Appl. No.: 14/055,219

(22) Filed: Oct. 16, 2013

(30) Foreign Application Priority Data
Nov. 13, 2012 (JP) 2012-249424

(51) Int. Cl. H04N 1/333

(52) U.S. Cl. CPC H04N 1/33361
USPC 358/434

(57) ABSTRACT

A communication apparatus which is capable of determining whether or not it is necessary to switch from IP FAX to analog FAX and resend an original, thus dispensing with an unnecessary resending process. When communication using a first connection unit, which connects to a network line, is unsuccessful, it is determined whether or not a device at a destination is a device connected to the network line via an analog line. When it is determined that the device at the destination is not a device connected to the network line via the analog line, communication with the device at the destination using a second connection unit, which connects to the analog line, is carried out.

### BACKGROUND OF THE INVENTION

1. Field of the Invention

The present invention relates to a communication apparatus, a control method therefor, and a computer-readable storage medium storing a program for implementing the control method, and in particular, to a technique for switching between IP FAX communication using a network line and analog FAX communication using an analog line.

2. Description of the Related Art

In recent years, devices equipped with an Internet FAX (IP FAX) function of carrying out facsimile (FAX) communications using a network line such as the Internet have been becoming widespread. For the devices having the IP FAX function, Session Initiation Protocol (SIP) is widely used so as to establish a stable session with a communication destination. The devices having the IP FAX function carry out communications by connecting to an IP telephone network provided by a telecommunications carrier.

There are also network environments using a VoIP (Voice over IP) gateway medicating between a network line and an analog line. In such environments, communications with the VoIP gateway are carried out using a network line between a sender and the VoIP gateway, and communications using an analog line are carried out between the VoIP gateway and a device at a communication destination.

On the other hand, devices equipped with an analog FAX function of carrying out communications using already existing analog lines are also generally used. For this reason, devices supporting IP FAX have both the IP FAX function and the analog FAX function in many cases. Such devices having both functions have a function of enabling both IP FAX communication and analog FAX communication and switching between IP FAX communication and analog FAX communication. For example, there has been proposed a technique that, when an error occurs during an attempt to send an original by IP FAX, causes device to automatically resend the original by analog FAX (see, for example, Japanese Patent Publication No. 4116213).

According to Japanese Patent Publication No. 4116213, however, even when switching from IP FAX communication to analog FAX communication is done, communication may end unsuccessfully in the same way, depending on an error occurring during communication by IP FAX and a network environment of a sender's device. For example, there may be a case where, when a device connected to a VoIP gateway tries to indirectly send an original to another device, which is on an analog telephone network, by analog FAX, the device at the transmission destination may be busy. In this case, even when the sender's device switches from IP FAX to analog FAX, the device at the transmission destination is still connected to an analog line, and hence busy even after switching. Namely, resending by analog FAX is an unnecessary process for the device.

### SUMMARY OF THE INVENTION

The present invention provides a communication apparatus and a control method therefor which are capable of determining whether or not it is necessary to switch from IP FAX to analog FAX and resend an original, thus dispensing with an unnecessary resending process, as well as a computer-readable storage medium storing a program for implementing the control method.

Accordingly, a first aspect of the present invention provides a communication apparatus comprising a first connection unit configured to connect to a network line, a second connection unit configured to connect to an analog line, a determination unit configured to, when communication using the first connection unit is unsuccessful, determine whether a device at a destination is a device connected to the network line via the analog line, and a communication control unit configured to, when the determination unit determines that the device at the destination is not a device connected to the network line via the analog line, carry out communication with the device at the destination using the second connection unit.

Accordingly, a second aspect of the present invention provides a communication apparatus comprising a first connection unit configured to connect to a network line, a second connection unit configured to connect to an analog line, a determination unit configured to, upon receipt of a message indicating that a device at a destination is busy when communication using the first connection unit is to be carried out, determine whether a sender of the message is the device at the destination, and a communication control unit configured to, when the determination unit determines that the sender of the message is the device at the destination, carry out communication with the device at the destination using the second connection unit.

Accordingly, a third aspect of the present invention provides a control method for a communication apparatus having a first connection unit that connects to a network line and a second connection unit that connects to an analog line, comprising a determination step of, when communication using the first connection unit is unsuccessful, determining whether a device at a destination is a device connected to the network line via the analog line, and a communication control step of, when it is determined in the determination step that the device at the destination is not a device connected to the network line via the analog line, carrying out communication with the device at the destination using the second connection unit.

Accordingly, a fourth aspect of the present invention provides a control method for a communication apparatus having a first connection unit that connects to a network line and a second connection unit that connects to an analog line, comprising a determination step of, upon receipt o a message indicating that a device at a destination is busy when communication using the first connection unit is to be carried out, determining whether a sender of the message is the device at the destination, and a communication control step of, when it is determined in the determination step that the sender of the message is the device at the destination, carrying out communication with the device at the destination using the second connection unit.

Accordingly, a fifth aspect of the present invention provides a non-transitory computer-readable storage medium storing a program for causing a computer to execute a control method for a communication apparatus having a first connection unit that connects to a network line and a second connection unit that connects to an analog line, the control method comprising a determination step of, when communication using the first connection unit is unsuccessful, determining whether a device at a destination is a device connected to the network line via the analog line, and a communication control step of, when it is determined in the determination step that the device at the destination is not a device connected to the network line via the analog line, carrying out communication with the device at the destination using the second connection unit.

Accordingly, a sixth aspect of the present invention provides a non-transitory computer-readable storage medium storing a program for causing a computer to execute a control method for a communication apparatus having a first connection unit that connects to a network line and a second connection unit that connects to an analog line, the control method comprising a determination step of, upon receipt o a message indicating that a device at a destination is busy when communication using the first connection unit is to be carried out, determining whether a sender of the message is the device at the destination, and a communication control step of, when it is determined in the determination step that the sender of the message is the device at the destination, carrying out communication with the device at the destination using the second connection unit.

According to the present invention, in a device having a function of switching from IP FAX to analog FAX and resending an original, whether or not it is necessary to resend an original is determined to dispense with an unnecessary resending process.

Further features of the present invention will become apparent from the following description of exemplary embodiments (with reference to the attached drawings).

### BRIEF DESCRIPTION OF THE DRAWINGS

FIG. 1A is a view showing an exemplary first network environment to which a communication apparatus according to an embodiment of the present invention is connected, and FIG. 1B is a view showing an exemplary second network environment to which the communication apparatus according to the embodiment of the present invention is connected.

FIG. 2 is a block diagram schematically showing an exemplary hardware arrangement of a device 101 appearing in FIG. 1.

FIG. 3 is a block diagram schematically showing an exemplary software arrangement of a communication function which the device 101 has.

FIG. 4A is a view showing an exemplary SIP message which the device 101 sends first when trying to establishing a session, FIG. 4B is a view showing an exemplary response message which the device 101 receives when the session is successfully established in response to INVITE, and FIG. 4C is a view showing an exemplary response message which the device 101 receives when establishment of the session is unsuccessful in response to INVITE due to a transmission destination being busy.

FIG. 5 is a flowchart showing the flow of a communication process carried out by the device 101.

FIG. 6 is a diagram schematically showing an exemplary software arrangement of a communication function which a device 101 according to a second embodiment has.

FIG. 7 is a view showing an exemplary FAX sending history screen displayed on an operation panel 205 of the device 101 according to the second embodiment.

FIG. 8 is a flowchart showing the flow of a communication process carried out by the device 101 according to the second embodiment.

### DESCRIPTION OF THE EMBODIMENTS

The present invention will now be described in detail with reference to the drawings showing embodiments thereof.

First, a description will be given of a network environment to which a communication apparatus according to an embodiment of the present invention is connected.

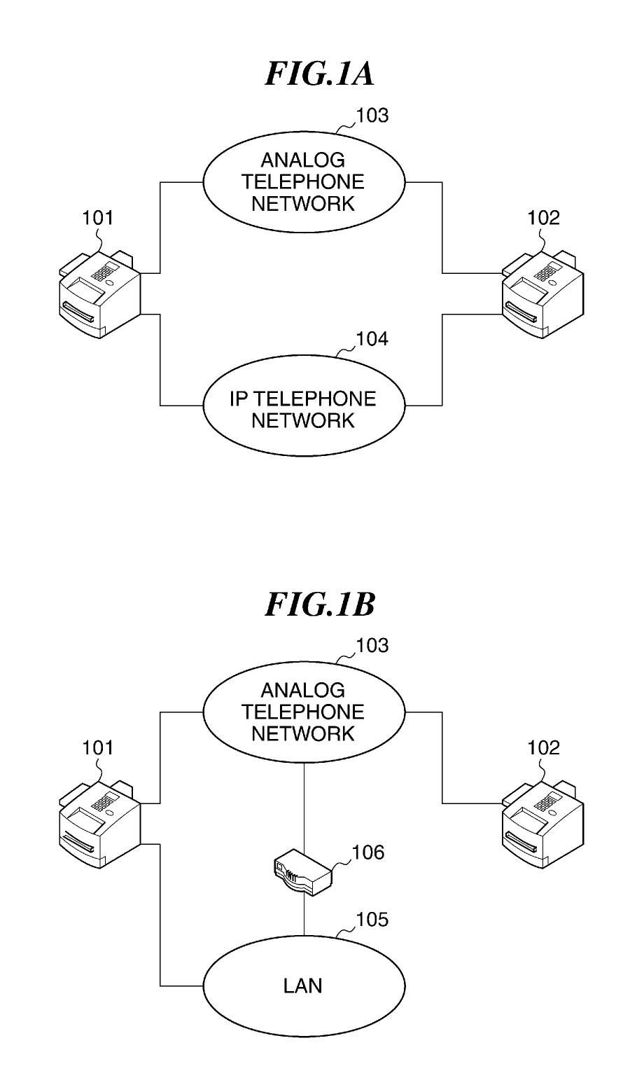

FIG. 1A is a view showing an exemplary first network environment to which the communication apparatus according to the embodiment of the present invention is connected, and FIG. 1B is a view showing an exemplary second network environment to which the communication apparatus according to the embodiment of the present invention is connected.

The communication apparatus according to the embodiment of the present invention is a device 101. The device 101 is an image forming apparatus having a FAX function. A device 102 is an image forming apparatus having a FAX function as with the device 101.

It should be noted that the device 101 and the device 102 may have the same arrangement or different arrangements. Both of them may be simple FAX machines or the like.

In the first network environment appearing in FIG. 1A, the device 101 and the device 102 are each connected to both an IP telephone network 104 (network line) and an analog telephone network 103 (analog line).

In the second network environment appearing in FIG. 1B, the device 102 is connected to only the analog telephone network 103. The device 101 is directly connected to the analog telephone network 103, and also connected to a LAN 105 (network line) and indirectly connected to the analog telephone network 103 as well via a VoIP gateway 106. Here, from the standpoint of the device 101, IP FAX communications are carried out between the LAN 105 and the VoIP gateway 106, and the VoIP gateway 106 converts IP FAX format to analog FAX format to do exchange.

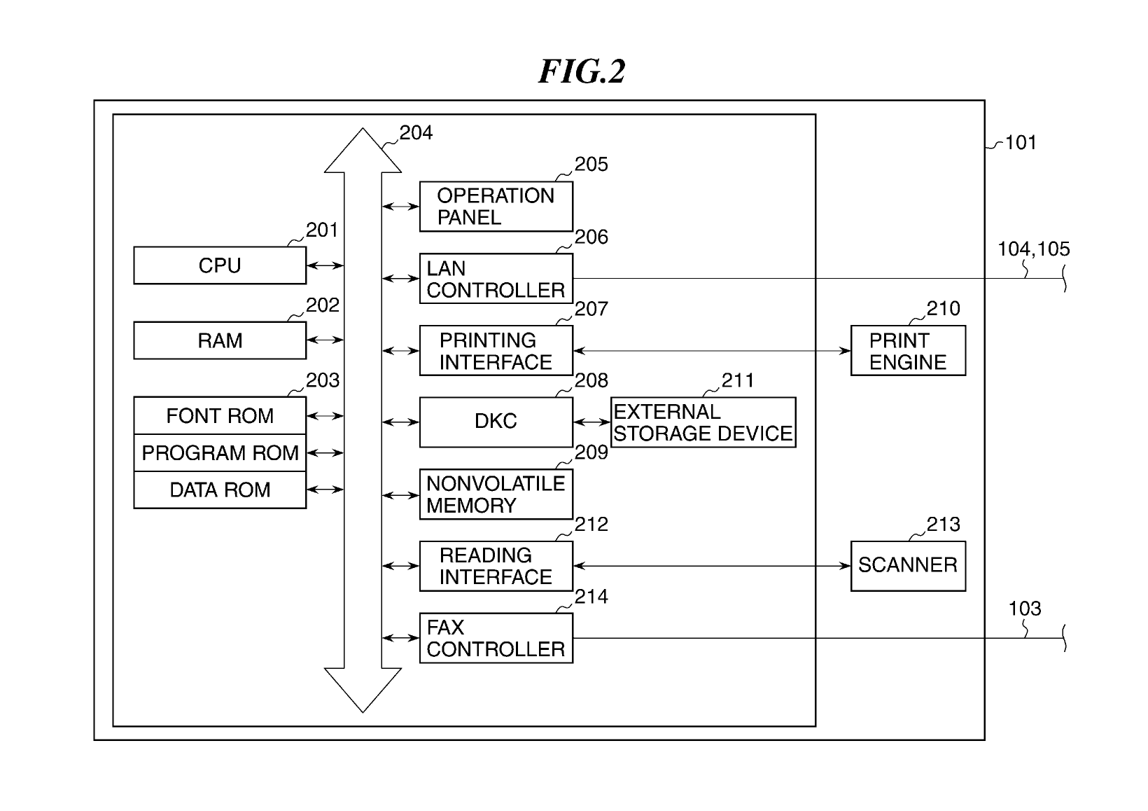

Next, a description will be given of a hardware arrangement of the device 101 appearing in FIG. 1 with reference to FIG. 2.

FIG. 2 is a block diagram schematically showing an exemplary hardware arrangement of the device 101 appearing in FIG. 1.

Referring to FIG. 2, a CPU 201 exercises control over access to various devices connected to a system bus 204 based on a control program stored in program ROM of a ROM 203 or an external storage device 211.

The CPU 201 also outputs image signals as output information to a printing unit (print engine) 210, to which the CPU 201 is connected via a printing interface 207, and controls image signals input from a reading unit (scanner) 213, to which the CPU 201 is connected via a reading interface 212.

In the program ROM of the ROM 203, control programs, which are executable by the CPU 201, and others are stored. In font ROM of the ROM 203, font data (including outline font data), which is for use in generating the output information, and others are stored. In data ROM of the ROM 203, information, which is used on a client computer, not shown, and others are stored.

The CPU 201 is capable of communicating with client computers (not shown) and devices (not shown) on a network line such as the LAN 105 by a LAN controller 206 (first communication).

The CPU 201 is also capable of communicating with communication destinations via the analog telephone network 103 by a FAX controller 214 (second communication).

RAM 202 acts mainly as main memory, work area, and so on for the CPU 201 and is configured to be able to increase memory capacity using optional RAM connected to an expansion port, not shown. It should be noted that the RAM 202 is used as an output information expansion area, an environmental data storage area, and so on.

The external storage device 211 is comprised of a hard disk (HDD), an IC card, or the like, and access thereto is controlled by a disk controller (DKC) 208. The external storage device 211 stores application programs, font data, form data, and so on. Further, the external storage device 211 is used to temporarily spool print jobs and used as a job storage area for externally controlling spooled jobs.

The external storage device 211 is also used as a BOX data holding area for holding image data read from the scanner 213 and image data of print jobs as BOX data. In the present embodiment, an HDD is used as the external storage device 211 and holds various logs such as job logs and image logs. It should be noted that the external storage device 211 is comprised of at least one HDD and may be configured such that a plurality of external memories storing optional font cards as well built-in fonts and programs which analyze printer control languages of different language systems can be connected to the external storage device 211.

The operation panel 205 enables a user to input a variety of information from software keys. A nonvolatile memory 209 stores a variety of setting information set via the operation panel 205.

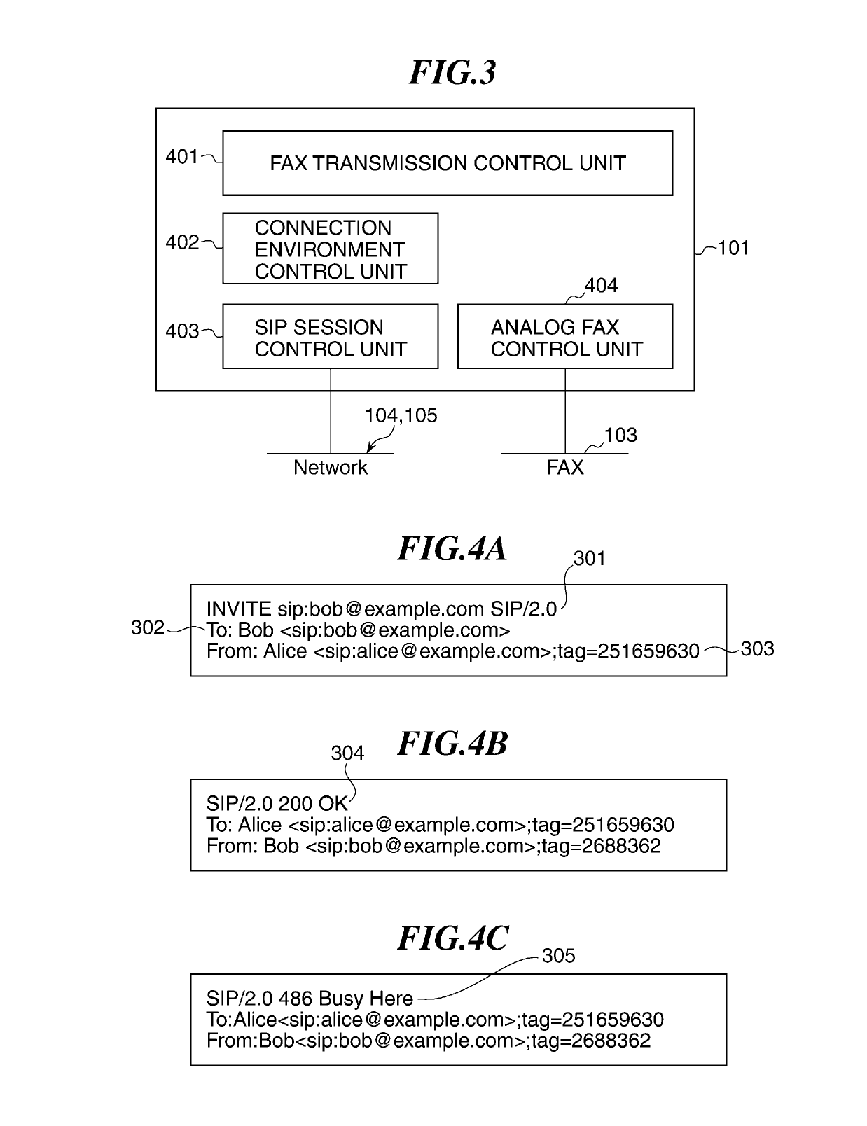

Referring next to FIG. 3, a description will be given of a software arrangement of the communication function which the device 101 has.

FIG. 3 is a block diagram schematically showing an exemplary software arrangement of the communication function which the device 101 has. It should be noted that a software program shown in the figure is stored in program ROM of the ROM 203 or the like and realized by the CPU 201 executing this program.

Referring to FIG. 3, a fax transmission control unit 401 controls overall processing relating to FAX transmission. For example, when image data of a an original read by the scanner 213 is to be transmitted, IP FAX or analog FAX is selected as a communication method, and the corresponding communication process is started. Which communication method is to be selected may be set by the user or automatically determined. Here, IP FAX is selected.

A connection environment control unit 402 determines whether a connection environment of the device 101 is the first network environment appearing in FIG. 1A or the second network environment appearing in FIG. 1B.

A SIP session control unit 403 manages communications for establishment, maintenance, and termination of SIP sessions. An analog fax control unit 404 provides control to send data of a read original by analog FAX.

A description will now be given of message exchanges in a case where a session is successfully established and a case where session establishment is unsuccessful due to a transmission destination being busy when an IP FAX session by SIP is to be established between the device 101 and the device 102.

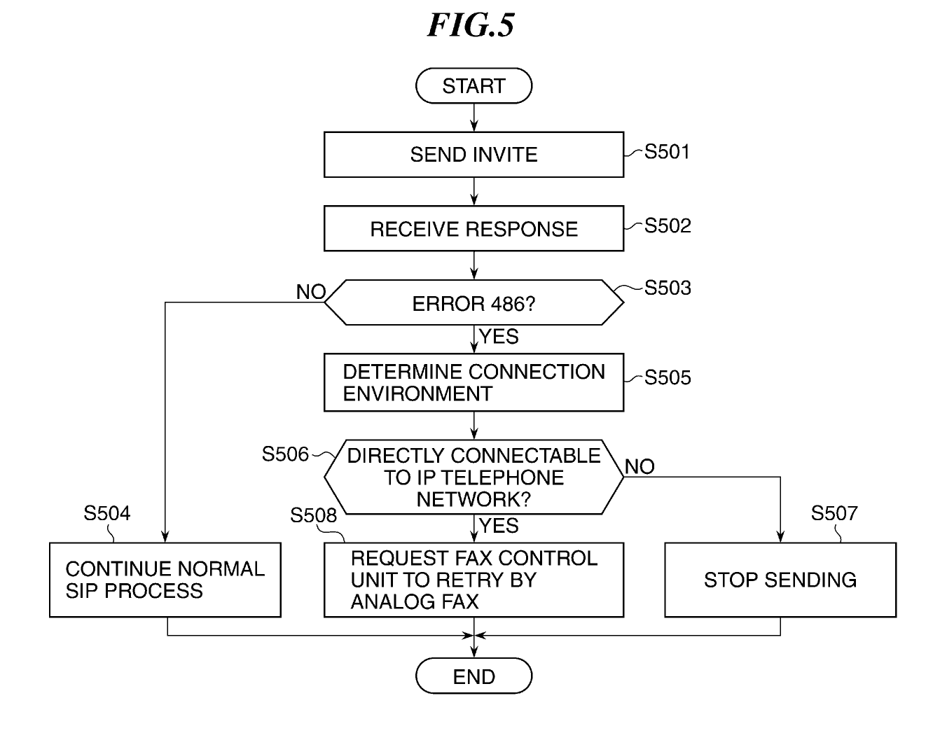

FIG. 4A is a view showing an exemplary SIP message which the device 101 sends first when trying to establishing a session.

Referring to FIG. 4A, a line 301 indicates that this message is INVITE defined by SIP. A line 302 is a SIP URI of the device 102 which is a transmission destination of an original. A line 303 is a SIP URI of the device 101 which is a sender. In the line 303, “tag” is a value that is uniquely set for this SIP URI.

To transmit an original in the first network environment appearing in FIG. 1A, first, the device 101 transmits the message appearing in FIG. 4A to the device 102 via the IP telephone network 104. It should be noted that in the description of the present embodiment, data is transmitted directly from the device 101 to the device 102 but may be transmitted by way of a server apparatus or the like which mediates between them.

On the other hand, to transmit an original in the second network environment appearing in FIG. 1B, first, the device 101 transmits the original to the VoIP gateway 106 via the LAN 105.

FIG. 4B is a view showing an exemplary response message which the device 101 receives when the session is successfully established in response to INVITE.

Referring to FIG. 4B, a part “200 OK” in a line 304 indicates that the session is successfully established. In the first network environment, this message is sent back from the device 102, and in the second network environment, this message is sent back from the VoIP gateway 106 via the LAN 105.

FIG. 4C is a view showing an exemplary response message which the device 101 receives when establishment of the session in response to INVITE is unsuccessful due to the transmission destination being busy.

Referring to FIG. 4C, a part “486 Busy Here” in a line 305 indicates that establishment of the session in response to INVITE is unsuccessful due to the transmission destination being busy.

As with the message appearing in FIG. 4B, in the first network environment, this message is sent back from the device 102, and in the second network environment, this message is sent back from the VoIP gateway 106 via the LAN 105.

Referring next to FIG. 5, a description will be given of the flow of the communication process carried out by the device 101 when a FAX communication is carried out between the device 101 and the device 102.

FIG. 5 is a flowchart showing the flow of the communication process carried out by the device 101.

In the device 101, transmission of image data is started by the FAX transmission control unit 401, the SIP session control unit 403 transmits INVITE appearing in FIG. 4A to the device 102 (step S501).

Next, in the device 101, when a response to the transmitted INVITE is received (step S502), details of the response are analyzed (step S503). When the response is a message (error 486) indicating that a line is busy, the process proceeds to step S505.

In the step S505, the connection environment control unit 402 determines whether or not an environment to which the device 101 itself is connected is the first network environment appearing in FIG. 1A or the second network environment appearing in FIG. 1B.

Next, based on the result of the determination in the step S505, the connection environment control unit 402 then determines in step S506 whether or not the process proceeds to step S508 or step S507. When it is determined that the device 101 lies in the first network environment in which it is directly connected to the IP telephone network 104, the analog telephone network 103 to which the device 102 is connected is likely to be free, the process proceeds to the step S508. In the step S508, the FAX transmission control unit 401 instructs the analog FAX control unit 404 to make an attempt to perform retransmission by analog FAX using the analog telephone network 103 (step S508).

On the other hand, when, as a result of the determination in the step S506, when the device 101 is connected to the analog telephone network 103 via the VoIP gateway 106, the analog telephone network 103 to which the device 102 is connected is busy, and hence the device 101 cannot connected to the device 102. In this case, retransmission using the analog telephone network 103 is not carried out (step S507).

When, as a result f the determination in the step S503, there is a response other than the one appearing in FIG. 4C to the SIP INVITE, normal SIP processing is continued (step S504). For example, the response indicates that a session is successfully established as shown in FIG. 4B, this session is managed thereafter.

The process described above eliminates the need to try unnecessary transmission by analog FAX in a case where in the network environment appearing in FIG. 1B, a sender's device receives a response message indicative of a destination being busy as shown in FIG. 4C.

In a second embodiment of the present invention, a connection mode (FIG. 1) and a hardware arrangement (FIG. 2) of a device are the same as those in the first embodiment described above. The components same as those of the first embodiment are designated by the same reference symbols, detailed description of which, therefore, is omitted. Only those differing from the first embodiment will be described below.

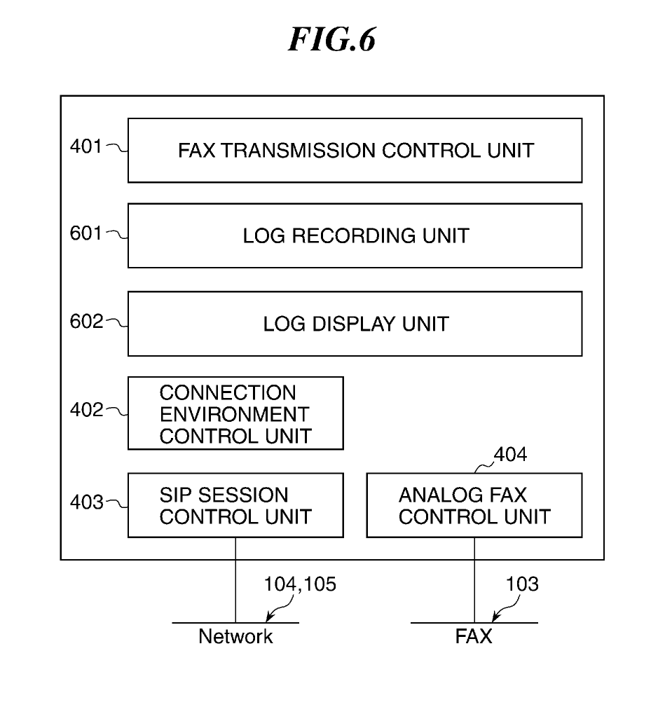

First, referring next to FIG. 6, a description will be given of a software arrangement of the communication function which the device 101 according to the second embodiment has.

FIG. 6 is a diagram schematically showing an exemplary software arrangement of the communication function which the device 101 according to the second embodiment has. It should be noted that in the example shown in the figure, a log recording unit 601 and a log display unit 602 are added as compared to the arrangement appearing in FIG. 3. The log recording unit 601 records a log (communication log) for keeping information as to whether a session by SIP is successfully established as a FAX history. The log display unit 602 displays the recorded log on the operation panel 205.

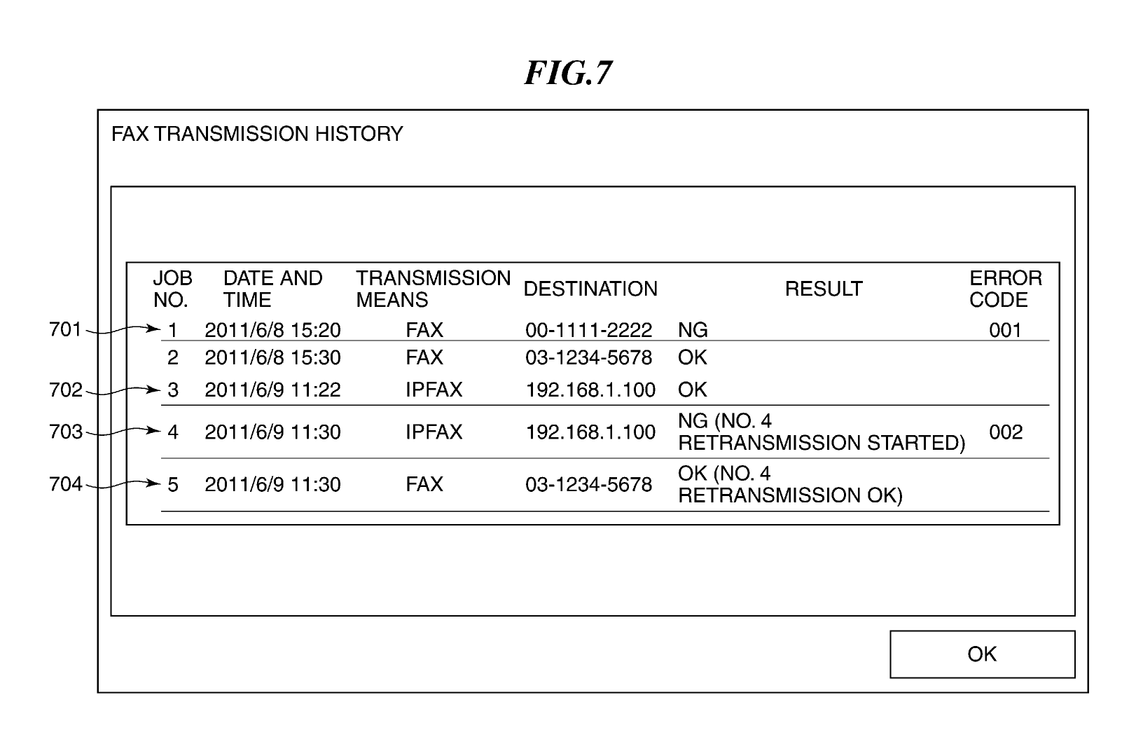

Referring next to FIG. 7, a description will be given of a FAX transmission history screen displayed on the operation panel 205 by the log display unit 602.

FIG. 7 is a view showing an exemplary FAX transmission history screen displayed on the operation panel 205 of the device 101 according to the second embodiment.

Referring to FIG. 7, a line 701 is a history of transmission by analog FAX. The example shown in the figure shows that transmission by analog FAX to a transmission destination number 00-1111-2222 is unsuccessful. A line 702 is a history of transmission by IP FAX. The example shown in the figure shows that transmission by IP FAX to a transmission destination 192.168.1.100 is successful.

In the present invention, a history of retransmission by analog FAX after unsuccessful transmission by IP FAX is left. On this occasion, as shown in a line 703, a history showing that transmission by IP FAX to the transmission destination 192.168.1.100 is unsuccessful is kept, and a history of retransmission by analog FAX is left in a line 704. Examples of histories may include a SIP response message, and a determination as to whether or not to carry out retransmission by analog FAX.

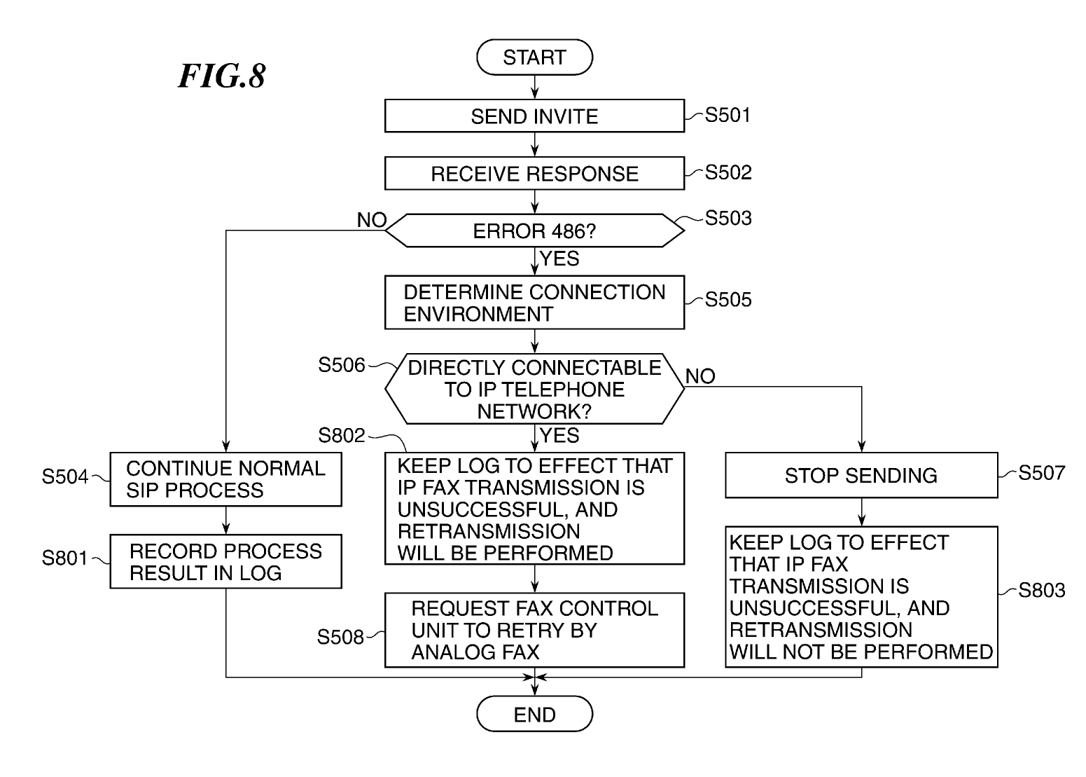

Referring next to FIG. 8, a description will be given of the flow of a communication process carried out by the device 101 according to the second embodiment when a FAX communication is carried out between the device 101 and the device 102 according to the second embodiment.

FIG. 8 is a flowchart showing the flow of the communication process carried out by the device 101 according to the second embodiment.

The process in FIG. 8 is substantially the same as the flowchart of FIG. 5. In the present embodiment, when the SIP session control unit 403 receives a response message which is a reply to INVITE, and IP FAX processing is completed, the log recording unit 601 records a log in a FAX transmission history. For example, when normal SIP processing is brought to an end in the step S504, the log recording unit 601 records the processing result in a log (logging) (step S801).

Also, when the response message appearing in FIG. 4C is received, the log recording unit 601 keeps a log to the effect that “processing by IP FAX is unsuccessful, and retransmission will be performed” prior to a process in which resending is performed by analog FAX (step S508).

When resending is not to be performed by analog FAX (step S507), the log recording unit 601 keeps a log to the effect that “processing by IP FAX is unsuccessful, and retransmission will not be performed” (step S803).

As a result of the above processes, the user can easily grasp of a FAX communication status.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-249424 filed Nov. 13, 2012, which is hereby incorporated by reference herein in its entirety.

What is claimed is:

1. A communication apparatus comprising:
a first connection unit configured to connect to a network line;
a second connection unit configured to connect to an analog line;
a determination unit configured to, when communication using said first connection unit is unsuccessful, determine whether a device at a destination is a device connected to the network line via the analog line; and
a communication control unit configured to, when said determination unit determines that the device at the destination is not a device connected to the network line via the analog line, carry out communication with the device at the destination using said second connection unit.

2. The communication apparatus according to claim 1, wherein when the device at the destination is a device connected to the network line via the analog line, communication using said first connection unit is carried out by way of a gateway device.

3. The communication apparatus according to claim 1, wherein said determination unit carries out the determination when receiving a message indicating that the device at the destination is busy.

4. The communication apparatus according to claim 1, wherein when the device at the destination is not a device connected to the network line via the analog line, communication with the device at the destination using said second connection unit is not carried out.

5. The communication apparatus according to claim 1, wherein communication using said first connection unit is carried out according to SIP (Session Initiation Protocol).

6. A communication apparatus comprising:
a first connection unit configured to connect to a network line;
a second connection unit configured to connect to an analog line;
a determination unit configured to, upon receipt of a message indicating that a device at a destination is busy when communication using said first connection unit is to be carried out, determine whether a sender of the message is the device at the destination; and
a communication control unit configured to, when said determination unit determines that the sender of the message is the device at the destination, carry out communication with the device at the destination using said second connection unit.

7. The communication apparatus according to claim 6, wherein the message is a response to INVITE transmitted to the device at the destination by the communication apparatus.

8. The communication apparatus according to claim 6, wherein when said determination unit determines that the sender of the message is not the device at the destination, communication with the device at the destination using said second connection unit is not carried out.

9. The communication apparatus according to claim 6, wherein when the sender of the message is a gateway device, said determination unit determines that the sender of the message is not the device at the destination.

10. The communication apparatus according to claim 6, wherein communication using said first connection unit is carried out according to SIP (Session Initiation Protocol).

11. A control method for a communication apparatus having a first connection unit that connects to a network line and a second connection unit that connects to an analog line, comprising:
a determination step of, when communication using the first connection unit is unsuccessful, determining whether a device at a destination is a device connected to the network line via the analog line; and
a communication control step of, when it is determined in said determination step that the device at the destination is not a device connected to the network line via the analog line, carrying out communication with the device at the destination using the second connection unit.

12. A control method for a communication apparatus having a first connection unit that connects to a network line and a second connection unit that connects to an analog line, comprising:
a determination step of, upon receipt o a message indicating that a device at a destination is busy when communication using the first connection unit is to be carried out, determining whether a sender of the message is the device at the destination; and
a communication control step of, when it is determined in said determination step that the sender of the message is the device at the destination, carrying out communication with the device at the destination using the second connection unit.

13. A non-transitory computer-readable storage medium storing a program for causing a computer to execute a control method for a communication apparatus having a first connection unit that connects to a network line and a second connection unit that connects to an analog line, the control method comprising:
a determination step of, when communication using the first connection unit is unsuccessful, determining whether a device at a destination is a device connected to the network line via the analog line; and
a communication control step of, when it is determined in the determination step that the device at the destination is not a device connected to the network line via the analog line, carrying out communication with the device at the destination using the second connection unit.

14. A non-transitory computer-readable storage medium storing a program for causing a computer to execute a control method for a communication apparatus having a first connection unit that connects to a network line and a second connection unit that connects to an analog line, the control method comprising:
a determination step of, upon receipt o a message indicating that a device at a destination is busy when communication using the first connection unit is to be carried out, determining whether a sender of the message is the device at the destination; and
a communication control step of, when it is determined in the determination step that the sender of the message is the device at the destination, carrying out communication with the device at the destination using the second connection unit.
